(19) United States
(12) Patent Application Publication
(10) Pub. No.: US 2025/0244768 A1
(43) Pub. Date: Jul. 31, 2025

(54) System and method for training AI Selectively-Autonomous, Selectively- Collaborative Low-Cost Attritable Aircraft (SA-SC-LCAA)

(71) Applicant: OnStation Corporation, Los Angeles, CA (US)

(72) Inventors: Lewis Allen Whaley, Charleston, WV (US); Mark Richard Jean, Palmdale, CA (US)

(73) Assignee: OnStation Corporation, Los Angeles, CA (US)

(21) Appl. No.: 19/039,764

(22) Filed: Jan. 28, 2025

Related U.S. Application Data
(60) Provisional application No. 63/626,477, filed on Jan. 29, 2024.

(51) Int. Cl. G05D 1/46; G05D 101/15; G05D 111/10

(52) U.S. Cl. CPC G05D 1/46; G05D 2101/15; G05D 2111/10

(57) ABSTRACT

A collaborative multi-agent artificial intelligence (AI) control system configured to operatively integrate with a selectively-autonomous, selectively-collaborative low-cost attritable aircraft (SA-SC-LCAA) is disclosed. The AI control system generally comprises one or more large maneuvering neural network models and one or more a large language neural network models that work together collaboratively, including neural network models configured to: receive pilot speech, attention, and biometric data, as well as aircraft switchology and control system actuation data from the low-cost attritable aircraft; receive aircraft operational data and time-space-position-information (TSPI) from the low-cost attritable aircraft; receive TSPI data for friendly aircraft, neutral aircraft, and or threat aircraft; generate at least one candidate aircraft flight trajectory/ies to fly a selected tactic that includes techniques and procedures (TTP); select one trajectory from the at least one candidate aircraft flight trajectory/ies to fly the aircraft to fly a selected TTP; and operate the low-cost attritable aircraft in accordance with the selected trajectory and TTP. In the preferred embodiment, the neural network model comprises a maneuvering, tactics, techniques, and procedures large language model (MTTP-LMM). The selected flight trajectory comprises a sequence of one or more planned maneuvers for the low-cost attritable aircraft to complete a selected TTP. The selected TTP can be displayed graphically along with the flight trajectories of other aircraft in proximity to the low-cost attritable aircraft. A physical model and energy-maneuverability model of the low-cost attritable aircraft may be employed to generate the at least one candidate aircraft flight trajectory and TTP.

### CROSS-REFERENCE TO RELATED APPLICATION(S)

This application claims the benefit of U.S. Provisional Patent Application Ser. No. 63/626,477, filed Jan. 29, 2024, titled “System and method for training AI Selectively-Autonomous, Selectively-Collaborative Low-Cost Attritable Aircraft (SA-SC-LCAA)”, which is hereby incorporated by reference herein for all purposes.

### TECHNICAL FIELD

The invention generally relates to a system for controlling an aircraft with one or more artificial neural networks. In particular, the invention relates to an artificial neural network configured to control maneuvering, tactics, techniques, and procedures using one or more large maneuvering models (LMMs) and one or more large language models (LLMs) that work together collaboratively.

### BACKGROUND

Modern aircraft are complex and therefore demand an immense amount of training to operate. Even with extensive training, however, pilots may be required to make consequential decisions with little or no time to evaluate the known options from which to choose. There is therefore a need for a solution that shares that burden with the pilot to enable them to make better decisions based on a wide range of dynamic factors.

### SUMMARY

The invention in the preferred embodiment features a collaborative multi-agent artificial intelligence (AI) control system configured to operatively integrate with a selectively-autonomous, selectively-collaborative low-cost attritable aircraft (SA-SC-LCAA). The AI control system generally comprises one or more large maneuvering neural network models and one or more a large language neural network models that work together collaboratively, including neural network models configured to: receive pilot speech, attention, and biometric data, as well as aircraft switchology and control system actuation data from the low-cost attritable aircraft; receive aircraft operational data and time-space-position-information (TSPI) from the low-cost attritable aircraft; receive TSPI data for friendly aircraft, neutral aircraft, and or threat aircraft; generate at least one candidate aircraft flight trajectory/ies to fly a selected tactic that includes techniques and procedures (TTP); select one trajectory from the at least one candidate aircraft flight trajectory/ies to fly the aircraft to fly a selected TTP; and operate the low-cost attritable aircraft in accordance with the selected trajectory and TTP.

In the preferred embodiment, the AI control system comprises a maneuvering, tactics, techniques, and procedures large language model (MTTP-LMM). The selected trajectory comprises a sequence of one or more planned maneuvers for the low-cost attritable aircraft to complete a selected TTP. The selected TTP can be displayed graphically along with the flight trajectories of other aircraft in proximity to the low-cost attritable aircraft. A physical model and energy-maneuverability model of the low-cost attritable aircraft may be employed to generate the at least one candidate aircraft flight trajectory and TTP.

Aircraft operational data generally comprises instrumentation and switch settings; digital display settings; and tactics, techniques, and procedures (TTP) required TSPI actions, decision point locations and decision options, and aircraft and subsystem actions. Aircraft operational data may further comprise the relative speeds, energy states, and positions of the aircraft and one or more threat aircraft; and inertial data including the forces on the low-cost attritable aircraft and its pilot. Aircraft operational data may also comprise operator and crew speech, and cockpit and/or control station aircraft control movements, helmet mounted display (HMD) display symbology and helmet movements, and pilot eye movements. Decision point locations and decision options are continuously updated through recurring observer-orient-decide-act (OODA) loop processes distributed among the AI neural network models.

In some embodiments, the AI control system is operatively integrated with a passive sensor active sensor large language model (PSAS-LMM) configured to receive data from a plurality of cameras and sensors; triangulate azimuth and altitude of at least one target based on the data received from the plurality of cameras and sensors; and calculate detect and track aircraft based on the azimuth and altitude of the at least one target.

In some other embodiments, the AI control system is operatively integrated with an electronic warfare large language model (EW-LMM) configured to perform meaconing, intrusion-jamming, interference, electronic support measures, electronic counter measures, and electronic counter counter-measures.

The AI control system may also include a computer vision, correlation large language model (CVC-LMM) configured to receive computer vision data from a plurality of cameras and sensors; correlate computer vision data of the plurality of cameras and sensors; determine when the quality of the computer vision data is not sufficient; and alter the weight of the computer vision data when it is not sufficient.

### BRIEF DESCRIPTION OF THE DRAWINGS

The present invention is illustrated by way of example and not limitation in the figures of the accompanying drawings, and in which:

FIG. 1 is a functional block diagram of a system for training and iteratively improving the performance of an artificial intelligence (AI) Selectively-Autonomous, Selectively-Collaborative Low-Cost Attritable Aircraft (SA-SC-LCAA), in accordance with a preferred embodiment of the present invention;

FIG. 2 is a functional block diagram of a large language model (LLM) and large maneuvering model (LMM), in accordance with a preferred embodiment of the present invention;

FIG. 3 is a flowchart of the process of training and operating the AI SA-SC-LCAA, in accordance with a preferred embodiment of the present invention.

### DETAILED DESCRIPTION OF THE PREFERRED EMBODIMENT

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

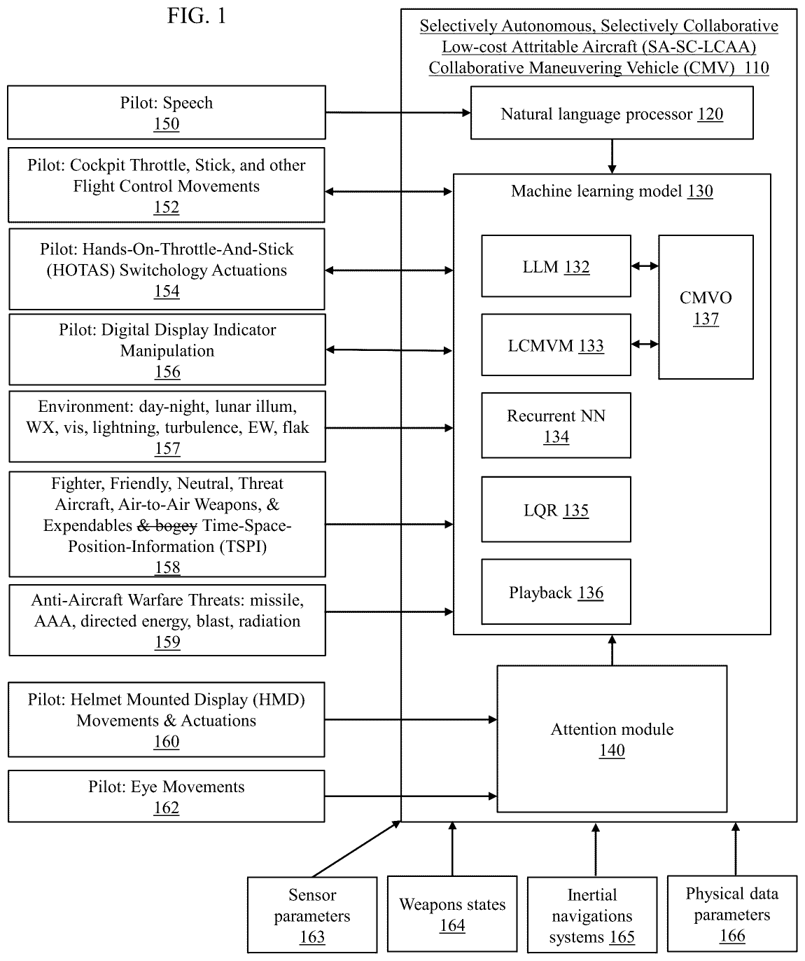

FIG. 1 is a functional block diagram of a system for training an artificial intelligence (AI) Selectively-Autonomous, Selectively-Collaborative, Low-Cost Attritable Aircraft (SA-SC-LCAA) system, in accordance with a preferred embodiment of the present invention. Once trained, the SA-SC-LCAA system 110 is configured to operate a Low-Cost Attritable aircraft (LCAA) flying the aircraft in an autonomous manner where the aircraft is completing all decisions and systems actuations based on the commands it receives, a semi-autonomous manner where the aircraft is being remotely controlled or partially remotely controlled by human operators geographically separated from the SA-SC-LCAA, or assist and advise the pilot onboard the SA-SC-LCAA on flying the aircraft with a user interface that enables the pilot to operate the aircraft with an enhanced level of information and situational awareness.

The SA-SC-LCAA system 110 is configured to receive a plurality of input data relevant to SA-SC-LCAA operations and automatically train a large language model (LLM) 132 and a large maneuvering model (LMM) 133 based on the input data, and where the terminology, definitions, neural network metadata, and other metadata of LLM 132 and the LMM 133 are correlated and kept in sync with a SA-SC-LCAA ontology (SA-SC-LCAA-O) 137. Using multisource input data to train the LLM 132 and LMM 133 creates and iteratively updates operational program specific rule sets to prescribe millions if not billions of SA-SC-LCAA maneuvering and operational instructions. The present invention, therefore, enables the LLM 132 and LMM 133 to be iteratively populated with countless SA-SC-LCAA maneuvering and operational instructions by recording one or more highly competent human pilot(s) maneuvering and operating specifically equipped aircraft and/or specifically equipped aircraft simulators.

The large maneuvering model (LMM) 133 is made up of at least ten domain-specific large maneuvering models (LMMs), including but not limited to a passive sensor, passive sensor probability of detection (PD), radar, active sensor, radar and active sensor PD, and sensor discipline LMM (PSAS-LMM) 210, an electronics warfare (EW), meaconing-intrusion-jamming-interference (MIJI), electronic support measures (ESM), electronic counter measures (ECM), and electronic counter measures (ECCM) LMM (EW-LMM) 212, a computer vision, correlation, and vision discipline LMM (CVC-LMM) 214, a multi-sensor integration LMM (MSI-LMM) 216, a positive identification (PID) and identification-friend-or-foe (IFF) LMM (PID-LMM) 218, a SA-SC-LCAA avionics, systems, predictive maintenance, status, energy maneuverability and capabilities, and digital thread LMM (EM-LMM) 220, a weapons employment, dynamic weapons ranging, weapons probability of kill (PK), and weapons discipline LMM (WEPS-LMM) 222, a maneuvering, tactics, techniques, and procedures LMM (MTTP-LMM) 224, a shared commander's intent and TTP orchestration LMM (CIO-LMM) 226, and a maneuvering TTP decision-support-system model LMM (DS-LMM) 228.

The SA-SC-LCAA system 110 in the preferred embodiment includes a natural language processor 120, machine learning (ML) module 130, and attention module 140. The natural language processor 120 is configured to receive audio of the operator speaking and convert that speech into text. The speech may include references to tactics, techniques, and procedures (TTP) manuals, aircraft flying manuals (AFM), aircraft operating manuals, classified and unclassified TTP articles, and/or standard operating procedures (SOPs) being executed by the crew, observations pertaining to the aircraft or situation experienced by the operator, instructions from the operator to other crew members, etc. The text, in turn, is provided as input to the ML module 130.

The attention module 140 is configured to receive data indicating the focal point of the operator's attention. The operator's attention can be inferred from the movements 160 of the helmet mounted display (HMD) as well as the gaze direction of the operator's eyes captured by the eye tracking system 162. The direction of the HMD and eyes can be correlated, for example, with an object of interest in the cockpit and/or aircraft control station, an instrument/gauge of interest, specific text or cue on a display, and/or an object in the environment in which the aircraft is being operated. If the operator, for example, turns his/her head and looks at the altitude gauge while executing a maneuver, it can be inferred that the altitude of the SA-SC-LCAA is important, and that behavior then correlated with the actual altitude when training the ML module 130. The attention info is then transmitted to the ML module 130. Operator instrument scan, reaction times, and biometric data such as heart rate and breathing rate, provide the ability to measure the operator's “situational awareness” and utilize this data to compute the level of human performance degradation at any given time.

The language query-response (LQR) module 135 is configured to accept ambiguous or missing data alerts 155 from both the machine learning model 130 and the natural language processor 120, the LQR module 135 being configured to ask questions of operators to clarify data ambiguity, fill in data gaps, as well as learn context, risk-levels, priorities, and acceptable decisions. Additionally, the LQR module 135 is configured to ask questions of operators to correlate specific data to ontological data. If the operator, for example, provides verbal instructions while maneuvering and viewing various objects, and the machine learning model 130 and/or the natural language processor 120 publish any ambiguous or missing data alerts, the LQR module 135 can query the operator with questions about the missing or ambiguous data, via a verbal exchange. Additionally, in an operations simulator environment, the LQR module 135 employs a “snapshot” scenario playback module 136 using the simulator to configure it to match the conditions being queried by the LQR module 135 as well as provide speech descriptions to the operator to illustrate the missing or ambiguous data and query the operator to clarify data ambiguity, fill in data gaps, as well as learn context, risk-levels, priorities, and acceptable decisions. The resulting clarification info is/are then transmitted to the ML module 130.

The ML module 130, in turn, includes a large language model (LLM) 132, a large maneuvering model (LMM) 133 and LMM's intrinsic domain-specific LMMs (134-143), recurrent neural network (RNN) 134, SA-SC-LCAA ontology (SA-SC-LCAA-O) 137, or combination thereof. The machine learning (ML) module 160, in the preferred embodiment, is configured to learn: (a) operator and crew speech 150, (b) cockpit and/or control station aircraft control movements 152, (c) instrumentation settings including switch settings 154 (aka, switchology), (d) digital display settings and how they are manipulated by the crew 156, (e) environmental (day-night, lunar illumination, weather, visibility, lightning, turbulence, electronic warfare, flak) (ENV) 157, (f) SA-SC-LCAA, friendly (blue air), neutral (white air), & bogey (red air) time-space-position-information (TSPI) 158, (g) Anti-Aircraft Warfare Threats: missile, anti-aircraft artillery (AAA), directed energy, blast, radiation, and other threats 159, (h) HMD movements 160 and eye movements captured by the eye tracking system 162, and (i) tactics, techniques, and procedures (TTP) from TTP manuals, aircraft flying manuals (AFM), aircraft operating manuals, classified and unclassified TTP articles, and/or standard operating procedures (SOPs).

The large maneuvering model (LMM) 133 contains large amounts of TSPI data, with the TSPI data specific to Tactics Techniques and Procedures (TTP) that are further categorized by the SA-SC-LCAA ontology (SA-SC-LCAA-O) 137 for mission, scenario, law of war, risk-levels, aircraft, vehicle, sensors, weapons, environments, threats, and/or other categorizations. The LLM 132, the LMM 133, and the LMM's intrinsic domain-specific LMMs (134-143) are trained together to levels of understanding that enable them to provide coordinated employment of maneuvers, sensors, weapons, and to perform other specific tasks. Individual entity and multiple entity coordinated LMM 133 creates proficiencies with TTP observations, orientations, decision-making, and action skillsets by iterating and learning from massive amounts of TSPI event data sets containing millions of related parameters, which are further related to a LLM 132, and with the LLM 132 and LMM 133 continually trained and performance-optimized. Separately and jointly, the LLM 132 and the LMM 133 are artificial intelligence neural networks.

The LLM 132 and LMM 133 SA-SC-LCAA ontology (SA-SC-LCAA-O) 137 provides the LLM 132 and LMM 133 machine learning (ML) the necessary models they need separately and jointly to overcome isolated objects, isolated relations and lack of reflections between objects, poor scalability, possibility of duplications, and chaos created by unmanaged structures. The SA-SC-LCAA ontology (SA-SC-LCAA-O) 137 provides LLM 132 and LMM 133 ML models with mission-, scenario-, risk-level-, aircraft-, vehicle-, sensor-, weapons-, environment-, threat-, TTP-, observation-, orientation-, decision-making-, and action skillset-specific knowledge and similarity analysis. The SA-SC-LCAA-O 137 includes an upper ontology, multiple domain ontologies, multiple interface ontologies, and multiple process ontologies. The SA-SC-LCAA-O 137, in conjunction with the LLM 132 and LMM 133 enables the Selectively-Autonomous, Selectively-Collaborative Low-Cost Attritable Aircraft (SA-SC-LCAA) to understand, make sense of, and consistently operate effectively in highly dynamic and seemingly unpredictable situations.

In some embodiments, the SA-SC-LCAA system is configured to encode aircraft operations in a large language model (LLM) 132, large maneuvering model (LMM) 133, LMM intrinsic LMMs (210, 212, 214, 216, 218, 220, 224, 226, 228), a SA-SC-LCAA-O 137, a recurrent neural network (RNN) 134, a language query-response (LQR) module 135, a “snapshot” scenario playback module 136, or combination thereof. The LLM 132 may, for example, be trained on written materials including training manuals, operating manuals, airplane flying manuals, aircraft operating and/or flight manuals, TTP manuals, classified and unclassified TTP articles, and/or standard operating procedure (SOP) manuals. The large maneuvering model (LMM) 133 and the LMM intrinsic LMMs (134-143) may, for example, be trained by historical Tactical Aircrew Combat Training Systems (TACTS) and/or Air Combat Maneuvering Instrumentation (ACMI) range data, operator verbal and written debrief reports and analyses, and machine learning/deep learning processed TACTS and/or ACMI data. The training data can then be implemented in terms of a statistical model that enables the crew to interact with the model, specifically query the model to ask questions or confirm procedures for aircraft operations. In some embodiments, the RNN 134 may be employed to learn different operational states of the aircraft and predict future states for purposes of operating the aircraft.

The RNN 134 may, for example, generate a “state vector” from a plurality of state variables. The state variables may include (a) all operator and crew speech 150 uttered within a predetermined time interval, (b) all aircraft operation control movements 152, (c) all instrumentation/switch settings 154, (d) all digital display settings 156, (e) the environmental (day-night, lunar illumination, weather, visibility, lightning, turbulence, electronic warfare, flak) (aka, ENV) 157, the relative speed, energy state, position of the aircraft and a bogey/unknown/enemy (aka, TSPI) 158, (f) Anti-Aircraft Warfare Threats: missile, anti-aircraft artillery (AAA), directed energy, blast, radiation, and other threats 159, (g) important cues or clues for human or SA-SC-LCAA systems to endeavor to learn and understand 162, (h) sensor systems states and field-of-view (FOV), ranges, and other critical sensor parameters 163, (i) weapons states, FOVs, ranges, and other critical weapons parameters 164, inertial navigations systems data (165), (j) physical data including the forces on the operator and airframe 166, (k) specific HMD movements 160 and specific eye movements captured by the eye tracking system 162, (l) tactics, techniques, and procedures (TTP), as well as correlated context, risk-levels, priorities, and acceptable decisions.

The state vector may then be provided to the RNN 134 for training using “backpropagation through time” (BPTT) or “Real-Time Recurrent Learning” (RTRL), for example. Once the RNN is trained and the link weights have converged on their respective values, the RNN 134 may be used to predict the next aircraft operation to execute based on the current situation as represented in the state vector. In this manner, the RNN 134 may encode thousands of operational sequences used, for example, to taxi the aircraft, take off, navigate to a destination, land, and avoid adversaries, for example.

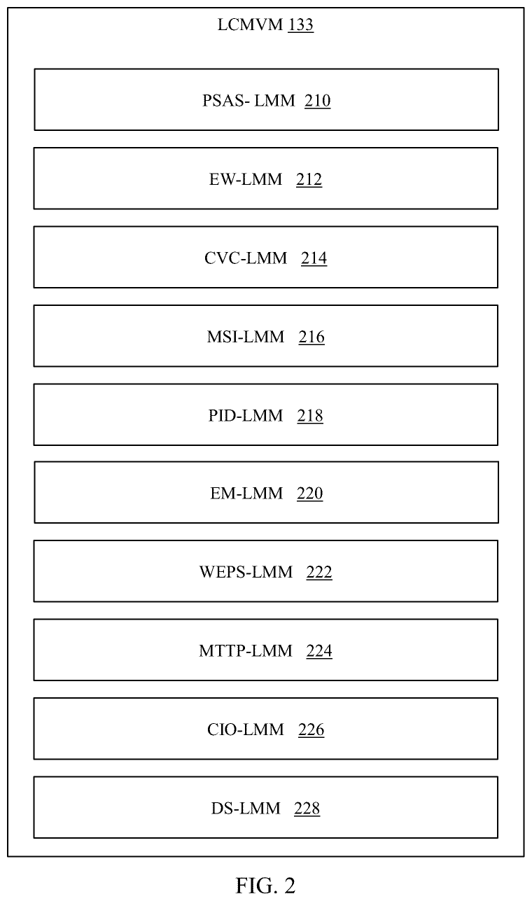

Illustrated in FIG. 2 is a functional block diagram of the large maneuvering model (LMM) 133, which comprises the following modules:
a) Passive sensor probability of detection (PD), radar, active sensor, radar and active sensor PD, and sensor discipline LMM (PSAS-LMM) 210.
b) Electronics warfare (EW), meaconing-intrusion-jamming-interference (MIJI), electronic support measures (ESM), electronic counter measures (ECM), and electronic counter measures (ECCM) LMM (EW-LMM) 212.
c) Computer vision, correlation, and vision discipline LMM (CVC-LMM) 214.
d) Multi-sensor integration LMM (MSI-LMM) 216.
e) Positive identification (PID) and identification-friend-or-foe (IFF) LMM (PID-LMM) 218.
f) SA-SC-LCAA avionics, systems, predictive maintenance, status, energy maneuverability and capabilities, and digital thread LMM (EM-LMM) 220.
g) Weapons employment, dynamic weapons ranging, weapons probability of kill (PK), and weapons discipline LMM (WEPS-LMM) 222.
h) Maneuvering, tactics, techniques, and procedures LMM (MTTP-LMM) 224.
i) Shared commander's intent and TTP orchestration LMM (CIO-LMM) 226.
j) Maneuvering TTP decision-support-system model LMM (DS-LMM) 228.

The Passive Sensor Active Sensor PSAS-LMM 210 is configured to (i) detect passive sensors, (ii) calculate passive sensor probability of detection (PD), (iii) detect radars and active sensors, (iv) calculate radar and active sensor PD, and (v) compute sensor discipline LMM. In particular, the PSAS-LMM 210 in the preferred embodiment is configured to optimize the acquisition of and determination of possible airborne hostile airspace or hostile targets (referred to herein as “red air” and “targets”, respectively, neutral airspace and neutral aircraft (referred to herein as “white air”), and friendly airspace and friendly aircraft (referred to herein as “blue air”). Red, white, and blue air are distinguished passively based on aircraft behaviors, emissions, and movements in relationship to the environment.

The PSAS-LMM 210 is configured to receive data from a plurality of cameras and/or sensors. The data from a plurality of cameras and/or sensors are then combined to triangulate azimuth and altitude of targets, thereby enabling the PSAS-LMM 210 to detect and track aircraft, detect aircraft type, detect target locations, detect country, and detect red, white, and blue air.

The Electronic Warfare EW-LMM 212 is configured to provide electronic warfare capabilities against hostile aircraft. The warfare capabilities include meaconing, intrusion-jamming, interference, electronic support measures (ESM), electronic counter measures (ECM), and electronic counter counter-measures (ECCM).

The CVC-LMM 214 comprises a computer vision artificial neural network (ANN) configured (i) to processes video that is captured by one or more video cameras or two-dimensional imagers, and (ii) to complete mission specific computer vision processing tasks. The computer vision processing tasks include (i) correlating computer vision data with other sensor systems data, (ii) “discerning” when the quality of the computer vision data is not sufficient, and (iii) altering the weight of vision data when it is not sufficient. When the quality of the vision data is deemed “not sufficient”, for example, the CVC-LMM 214 can select a different sensor system to use, preferably one that can actually detect and track an object with higher fidelity in context of the operational environment. In this manner, the system can de-weight or deactivate a vision system relative to other sensors if, for example, it experiences decreased visibility due to clouds, or a decrease in light due to the sun setting.

In operation, the CVC-LMM 214 is configured to correlate computer vision graphs with additional sensor data from other imaging systems, for example. When observing another aircraft or object, for example, the CVC-LMM 214 may correlate objects depicted is a plurality of vision systems or sensor systems by first matching the object of interest in the different vision systems and then comparing the quality with which the object is observed in the different vision systems. The matching may be based on Time-Space-Position Information (TSPI) including the spatial location of the object, the elevation of the object, the heading of the object, rate of climb or descent of the object, and/or the object's airspeed, for example. When this data correlates across multiple vision systems and sensor systems, then the CVC-LMM 214 can go on to distinguish which of the vision systems or sensor systems can be utilized by the CVC-LMM 214 and which cannot.

When a vision system being used to observe an object fails to discern the object with sufficient fidelity, the vision system that is unable to discern the object may be de-weighted in order to enhance reliance of the CVC-LLM 214 on the other vision systems and sensors that are still able to discern the object with relatively high fidelity. That is, the CVC-LLM 214 changes the weighting of the lower-quality computer vision vs other higher-quality sensors based on visibility and lighting, thereby decreasing its contribution to the processing while increasing the contribution of alternate sensors. The set of alternate sensors may include lasers/reflected signals, radars/reflected signals, LiDAR/reflected signals, GPS, VORs, VORTACs, TACANs, celestial navigation data, and inertial navigation unit (INU) data.

The CVC-LMM 214 in the preferred embodiment is configured to receive inputs from a plurality of sources. These sources may, but need not necessarily, include a wide range of sensor data and specific mission requirements. The sensor data may include ambient light (current light level measured), almanac of expected light levels, computer vision video, laser data, radar data, LiDAR data, GPS data, VORTAC data, TACAN data (ground transmitted navigation signals), celestial navigation data (use of X-ray emitting stars to determine TSPI), and INUs (ring laser gyros that maintain accurate position/orientation). The specific mission requirements, which encompass specific mission needs, include landing on an airport with no weather occluding visibility during daytime ops, as well as landing on an airport with rain partially occluding visibility during nighttime ops.

In addition, metadata may be attached to the TSPI data output. The meta data may include, for example, date & time information, aircraft model & serial number, sensor data type (computer vision, Laser, Radar, LiDAR, GPS, VOR, VORTAC, TACAN, Celestial nav, INU), sensor model/serial number, sensor weighting (current for conditions), and current environmental conditions.

The MTTP-LMM 224 is configured to generate a set of one or more potential aircraft flight trajectories and choose one of the trajectories to fly the aircraft based on what is happening in the moment, i.e., a “snapshot” of the current situation. Based on the selected trajectory at each moment in time, the MTTP-LMM 224 is configured to translate the trajectory into instructions sent to aircraft and system control LMMs to control the aircraft and its subsystems. Another LMM may be employed to monitor actual performance of the aircraft and report back to LMM 224 so it may deterministically update tactical details based on the current aircraft capabilities.

A flight trajectory, as used herein refers to a “sequence of one or more planned maneuvers” for the aircraft. Each trajectory is modeled by means of a software object that can be imported into a simulator flying session using the DIS or HLA distributed simulation data packet protocols. Using appropriate software, a flight trajectory may be represented graphically in a flight simulator environment so the user can “see” the flight path. Multiple flight trajectories, including the flight trajectories of other aircraft in the vicinity, may be presented or otherwise displayed at the same time.

Generation of the set of one or more potential aircraft flight trajectories is based on a combination of “physical models” of what should occur with an aircraft based on the physical capabilities of the aircraft and its “energy-maneuverability”. When selected, the MTTP-LMM 224 proceeds to generate a small multidata file that is then transmitted to the LMMs controlling the aircraft & its systems. The process of selecting and generating a flight trajectory is repeated many times second.

In the preferred embodiment, the MTTP-LMM 224 is trained based on TTPs (tactic, relevant techniques, and procedures), herein referred to as “tactics”. Once trained, the MTTP-LMM 224 is configured to map out flight trajectories and TTPs, map out the desired “approaches” to the desired tactics (if out of position), map out collaborative “maneuver warfare” with friendly wingmen to influence the bogeys/bandits, connect to the sensor LMMs to build situational awareness, connect to the “maneuvering TTP decision-support-system model” DS-LMM 228 in order to continuously compare correct decisions from MTTP-LMM 224 with error data from DS-LMM 228, i.e., perform error checking and ensure they agree with each other.

In some embodiments, the MTTP-LMM 224 is further configured enable multiple aircraft to complete tactics together using a “digital thread exchange”. With the exchange of this digital thread, two or more aircraft can collaborate and synchronize their flight trajectories to achieve a common objective.

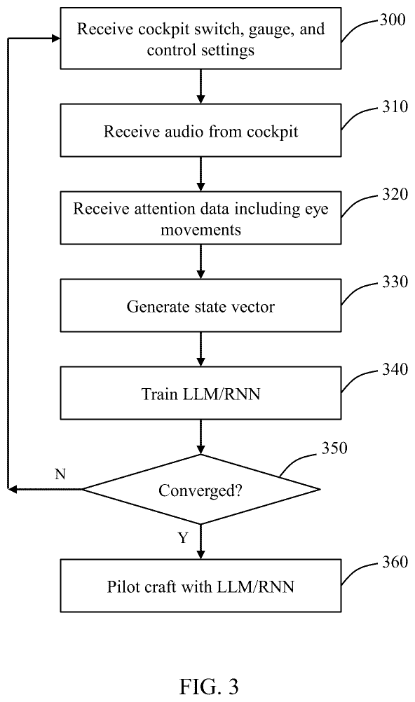

Illustrated in FIG. 3 is a flowchart of the process of training and operating the SA-SC-LCAA system. To start, the SA-SC-LCAA system receives 300 cockpit switch, gauge, and control settings. It also receives 310 audio from cockpit as well as attention data 320 based on the operator's head and eye movements. The switch, gauge, and control settings, speech data, and attention data are then compiled 330 into a state vector provided to the train 340 the LLM and/or RNN. The process is repeated until the link weights between nodes of the LLM and/or RNN converge and decision block 350 answered in the affirmative. Once trained, the LLM and/or RNN may be used to pilot 360 a aircraft. Moreover, the SA-SC-LCAA system can be trained on data acquired from multiple expert operators, giving rise to an autonomous system that may be as good if not better at operating a aircraft than the individual operators used to train the SA-SC-LCAA system.

While the SA-SC-LCAA system in the preferred embodiment was trained with aircraft operations data acquired during human operation, other embodiments may employ artificial intelligence and machine learning (AI/ML) operator systems training.

The AI/ML model in some embodiments is configured to (a) determine multiple operational sequences of user actions that pertain to the operation of an aircraft or other system from training data, (b) interact with pilots to determine whether or not the pilots are properly executing the determined sequences, and (c) take action if the pilots fail to execute the proper operation steps, all using the generative AI/ML model. The training data used to determine the sequences of user actions for operating an aircraft or other system are determined from manuals that recite standard operational procedures (SOPs), documents, audio, video, video displays and other user interfaces, dashboards, gauges, dials, switches, flight simulations, and supervised input, for example.

In some embodiments, the AI/ML model is a generative AI model configured to generate one or more types of content, such as text, imagery, audio, and synthetic data. Various types of generative AI models may be employed, including, but not limited to, large language models (LLMs), generative adversarial networks (GANs), variational autoencoders (VAEs), transformers, etc. Instead of single AI/ML model, some embodiments employ a plurality of AI/ML models to monitor operational sequences. Each AI/ML model may be a deep learning neural network (DLNN) of trained artificial “neurons” that are trained on training data, for example. Typically, the neural network architecture includes an input layer, multiple intermediate layers, and an output layer. In some embodiments, AI/ML models may have multiple layers that perform various functions, such as statistical modeling using a hidden Markov model (HMM), for example, and utilize deep learning techniques such as long short term memory (LSTM) deep learning, and the encoding of previous hidden states to perform the desired operational sequence.

Once the AI/ML model(s) has been trained and deployed in an aircraft, for example, audio and/or video from cockpit is provided as input to the AI/ML model. The AI/ML model processes the audiovisual data for the purpose of identifying the actions of the pilots. The actions of the pilots are compared to the proper SOP sequence of actions for operating the aircraft. If and when a pilot fails to take appropriate action, the AI/ML model may generate an alert to notify the pilot of one or more actions prescribed by the SOP or take over flight of the aircraft in extreme situations.

The AI/ML model may be configured to encode and recognize numerous operational sequences, each sequence including a plurality of actions or steps to be taken by operators in the aircraft, operators on the ground, and other aircraft, for example. Example operational sequences of user actions may include, for example, aircraft boarding sequences, aircraft taxiing sequences, aircraft take-off sequences, aircraft landing sequences, aircraft de-plane sequences.

In some embodiments, the SOP operational steps of an SOP sequence are represented as n-grams of multiple sizes. The n-grams may be used to search for matching sequences in the data, each element of the n-gram being associated with an action to be executed by one or more of the pilots collaborating to achieve a desired result or outcome. In some embodiments, the generative AI/ML model may automatically choose a minimum value for n based on a maximum number of matching sequences. The operational sequence can then be matched with the actions of the aircraft crew to identify the proper SOP sequence, and then compare the crew's actions with that SOP sequence. In certain embodiments, a certain number of matches may be required for a sequence of a certain n-gram size to be considered.

Recurrent neural networks (RNNs) may be particularly adept at determining useful ranges of the values of n. An RNN may determine the optimum windowing threshold (i.e., the useful range of n values) via a trial-and-error process that involves a sweep of n-grams of varying sizes for useful sequences, and potentially a sweep of all sequence sizes in some embodiments. The RNN can then determine the most optimal range, potentially without human input. To extract SOP sequences from training data, n-grams may be applied using a sliding window. For instance, if the current value of n is 15, the first 15 interactions by a user may be compared to all time-ordered sequences of 15 interactions from other operators, then interactions 12-16, 13-17, 14-18, etc. may be compared until all time ordered sets of the user's interactions of that size have been compared to those of other users being considered.

Some SOP sequences of actions can be configured to accomplish the same task with slightly differ procedures. In order to identify that such sequences are functionally the same, some embodiments generate a probability graph that includes loose associations of actions and outcomes. Each possible or observed interaction, or a subset thereof, may be included as a node in the graph. The generative AI/ML model may calculate the probability that a user would hop from one node to another (i.e., the probability that a user would follow an edge between nodes). Edges may provide probabilities between nodes, and potentially of a sequence of nodes as a series of segments therebetween. Such a sequence and its edges may provide a collective probability of starting at one node and arriving at another node via the sequence.

In some embodiments, the generative AI/ML model may be configured to automatically complete new SOP sequences based on observing example sequences in the training data. For example, if the AI/ML model encodes the operational sequence to taxi an aircraft to a particular runway of a particular airport, the generative AI/ML model may be configured to generate a procedure for taxiing any aircraft to the same or similar runway at the same airport based on the original operational sequence. The generative AI/ML model could be a deep learning neural network (DLNN)-trained, generative adversarial network (GAN)-trained, a combination thereof, etc.

In some embodiments, the generative AI/ML model may be trained to recognize desirable outcomes and to determine an SOP sequence or other operation sequence that leads to those desirable outcomes. The generative AI/ML model may, for example, be trained to recognize when an aircraft is in a dangerous situation and the actions that successfully minimized the danger or actions that avoided the dangerous situation all together. To do so, the generative AI/ML model may be configured to look backward in the training data pertaining to the pilot actions to recreate the sequence that led to the desirable outcome. The generative AI/ML model or another process could then associate the interactions with activities and generate an operational sequence that executes the SOP procedure.

In some embodiments, backpropagation may be used for training the AI/ML model. Backpropagation is a technique for optimizing synaptic weights in a feedforward artificial neural network. That is, backpropagation is used to adjust synaptic weights between nodes of the network as well as the bias associated with the nodes in order to minimize the difference between the predicted outputs and the actual outputs in the training dataset. This allows for strengthening of the nodes that lead to a desirable outcome. The weights associated with the nodes that lead to the desirable outcome may be iteratively strengthened until the desirable outcome can be reproduced.

Backpropagation may be guided by a cost function, such as mean square error (MSE) or gradient descent, that measures the similarity between the input training data and the output generated by the LLM. If the cost function is small, only small changes may be required to the link weights connecting nodes of the AI/ML model. If the cost function is large, the link weights of nodes that contributed to the cost may be further reduced to minimize their impact on the output.

In some embodiments, the invention further includes an assistant chatbot to enable pilots to maintain a dialog with the AI/ML model. The dialog may, in turn, be used by the pilots to query the AI/ML model as to the nature of the SOP sequence to be applied, the nature of any deviation from the operational sequence, and possible remedies to cure the deviation. The chatbot may employ on a natural language processor (NLP) such as word2vec, BERT, GPT-3, ChatGPT, or other LLMs to enable the AI/ML model to possess a semantic understanding of the (a) SOP's on which the system is trained, (b) the verbal utterances spoken by pilots in the aircraft, for example, and (c) provide human-like instructions to the pilots when they deviate from the applicable SOP.

One or more embodiments of the present invention may be implemented with one or more computer readable media, wherein each medium may be configured to include thereon data or computer executable instructions for manipulating data. The computer executable instructions include data structures, objects, programs, routines, or other program modules that may be accessed by a processing system, such as one associated with a general-purpose computer or processor capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. Examples of mass storage devices incorporating computer readable media include hard disk drives, magnetic disk drives, tape drives, optical disk drives, and solid state memory chips, for example. The term processor as used herein refers to a number of processing devices including personal computing devices, mobile phones, servers, general purpose computers, special purpose computers, application-specific integrated circuit (ASIC), and digital/analog electronic circuits with discrete components, for example.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

I/We claim:

1. An artificial intelligence (AI) control system configured to operatively integrate with a selectively-autonomous, selectively-collaborative low-cost attritable aircraft (SA-SC-LCAA), the AI control system comprising:
a neural network model comprising one or more large maneuvering neural network models and one or more a large language neural network models collaboratively coupled to the one or more large maneuvering neural network models, wherein the neural network model is configured to:
a) receive pilot speech and attention data, and aircraft actuation data from the low-cost attritable aircraft;
b) receive aircraft operational data and time-space-position-information (TSPI) from the low-cost attritable aircraft;
c) receive TSPI data for friendly aircraft, neutral aircraft, and or threat aircraft;
d) generate at least one candidate aircraft flight trajectory to fly a selected tactic comprising techniques and procedures (TTP);
e) select one trajectory from the at least one candidate aircraft flight trajectory to fly the aircraft; and
f) operate the low-cost attritable aircraft in accordance with the selected trajectory.

2. The AI control system of claim 1, wherein the neural network model comprises a maneuvering, tactics, techniques, and procedures large language model (MTTP-LMM).

3. The AI control system of claim 2, wherein the selected trajectory comprises a sequence of one or more planned maneuvers for the low-cost attritable aircraft to complete a selected TTP.

4. The AI control system of claim 3, wherein the MTTP-LMM is further configured to graphically display the selected trajectory.

5. The AI control system of claim 4, wherein the MTTP-LMM is further configured to graphically display multiple flight trajectories including (i) the selected trajectory and (ii) one or more flight trajectories of other aircraft in proximity to the low-cost attritable aircraft.

6. The AI control system of claim 3, wherein the at least one candidate aircraft flight trajectory is generated based on a physical model of the low-cost attritable aircraft.

7. The AI control system of claim 6, wherein the at least one candidate aircraft flight trajectory is generated based on an energy-maneuverability model of the low-cost attritable aircraft.

8. The AI control system of claim 2, wherein the aircraft operational data comprises:
instrumentation and switch settings;
digital display settings; and
tactics, techniques, and procedures (TTP) required TSPI actions, decision point locations and decision options, and aircraft and subsystem actions.

9. The AI control system of claim 8, wherein the aircraft operational data further comprises:
relative speed and position of the aircraft and a threat aircraft; and
inertial data including the forces on the low-cost attritable aircraft and its pilot.

10. The AI control system of claim 9, wherein the aircraft operational data further comprises:
operator and crew speech; and
cockpit and/or control station aircraft control movements.

11. The AI control system of claim 10, wherein the aircraft operational data further comprises:
helmet mounted display (HMD) movements; and
pilot eye movements.

12. The AI control system of claim 2, wherein the MTTP-LMM comprises a recurrent neural network.

13. The AI control system of claim 12, wherein the recurrent neural network is further configured to receive a state vector comprising the aircraft operational data.

14. The AI control system of claim 2, further comprising a passive sensor active sensor large language model (PSAS-LMM) configured to:
receive data from a plurality of cameras and sensors;
triangulate azimuth and altitude of at least one target based on the data received from the plurality of cameras and sensors; and
calculate detect and track aircraft based on the azimuth and altitude of the at least one target.

15. The AI control system of claim 2, further comprising an electronic warfare large language model (EW-LMM) configured to:
perform meaconing, intrusion-jamming, interference, electronic support measures, electronic counter measures, and electronic counter counter-measures.

16. The AI control system of claim 2, further comprising a computer vision, correlation large language model (CVC-LMM) configured to:
receive computer vision data from a plurality of cameras and sensors;
correlate computer vision data of the plurality of cameras and sensors;
determine when the quality of the computer vision data is not sufficient; and
alter the weight of the computer vision data when it is not sufficient.
